(19) United States
(12) Patent Application Publication
(10) Pub. No.: US 2021/0301482 A1
(43) Pub. Date: Sep. 30, 2021

(54) DRUM ASSEMBLY

(71) Applicant: Dickson Industries, Inc., Tecumseh, OK (US)

(72) Inventor: Wayne E. Dickson, Tecumseh, OK (US)

(21) Appl. No.: 17/217,468

(22) Filed: Mar. 30, 2021

Related U.S. Application Data
(60) Provisional application No. 63/002,561, filed on Mar. 31, 2020.

(51) Int. Cl. E01C 23/088; B28D 1/18

(52) U.S. Cl. CPC E01C 23/088; B28D 1/188

(57) ABSTRACT

A cutter head assembly for cutting slots in a surface includes a cutter drum. A plurality of first cutter bits are connected to the cutter drum and extend radially outwardly a first distance from a cutter drum face. First and second cutter plates are connected to first and second sides of the cutter drum. A plurality of second cutter bits are connected to the first and second cutter plates and extend radially outwardly a second distance from the cutter drum face, the second distance being greater than the first distance.

### CROSS-REFERENCE TO RELATED APPLICATION

This application claims the benefit of U.S. Provisional Application No. 63/002,561 filed Mar. 31, 2020, which is incorporated herein by reference.

There are a number of machines used for cutting, grinding and grooving surfaces such as road surfaces. Often the surfaces are cut using machinery that rotates a cutter drum with bits attached thereto. In some cases, there is a need for a cutter that will cut a groove that has groove portions with different depths.

### DESCRIPTION OF THE DRAWINGS

FIG. 1 is a perspective view of a cutter head assembly.

FIG. 2 is a side view of the cutter head assembly.

FIG. 3 is a front view of the cutter head assembly.

FIG. 4 is a perspective view of a cutter plate segment.

FIG. 5 is a side view of a cutter plate segment.

FIG. 6 is a perspective view of a second cutter bit.

FIG. 7 is a side view of a second cutter bit.

FIG. 8 is view showing the connection of a first cutter bit to a cutter drum.

FIG. 9 is a perspective view of a first cutter bit.

FIG. 10 is a side view of the cutter bit of FIG. 9.

FIG. 11 is a section view of the cutter bit of FIG. 9.

FIG. 12 is a view of first cutter bit connections to a cutter drum.

FIG. 13 is a side view of a cutter drum.

FIG. 14 is a front view of the cutter drum.

FIG. 15 is a perspective view of a cutter drum.

FIG. 16 is a partial perspective view of the cutter drum and cutter plate segments.

FIGS. 17-19 are views of a groove cut with the cutter head assembly.

FIG. 20 shows grooves cut in a road surface.

FIG. 21 shows the cutter head assembly attached to a tool.

FIG. 22 shows the cutter head assembly attached to a wheeled vehicle.

FIG. 23 is an additional embodiment of a cutter drum.

FIG. 24 is a side view of the embodiment of FIG. 23.

FIG. 25 is a front view of the embodiment of FIG. 23.

FIG. 26 is an example of a marker used in a roadway.

### SUMMARY

The current disclosure is directed to a cutter head assembly. The cutter head assembly is configured to connect to a piece of equipment that will rotate the cutter head assembly to make cuts in a roadway.

A cutter head assembly for cutting slots in a surface comprises a cutter drum, a plurality of first cutter bits connected to the cutter drum, the first cutter bits extending radially outwardly a first distance from a cutter drum face, first and second cutter plates connected to first and second sides of the cutter drum, and a plurality of second cutter bits connected to the first and second cutter plates. The second cutter bits extend radially outwardly a second distance from the cutter drum face, the second distance being greater than the first distance.

In one embodiment the first and second cutter plates of the cutter head assembly comprise a plurality of cutter plate segments, each cutter plate segment having a plurality of second cutter bits connected thereto.

In one embodiment the first and second cutter plates comprise a plurality of substantially similarly shaped segments. Each cutter head segment in one embodiment is a segment laterally offset from an adjacent cutter plate segment.

The first and second cutter plates are bolted to the cutter drum in some embodiments and the second cutter bits are welded to the first and second cutter plates.

In some embodiments the first cutter bits comprise first and second outer circumferential rows of first cutter bits, and at least one inner circumferential row of first cutter bits, the first and second outer rows being positioned immediately adjacent the first and second cutter plates.

In one embodiment a cutter for cutting a groove in a ground surface comprises a cylindrical cutter drum, a plurality of cutter bit slots defined in a cutter drum face, the cutter bit slots being arranged in circumferential rows comprising first and second outer circumferential rows and at least one inner circumferential row. The cutter bit slots in the first and second outer circumferential rows have first and second ends and a first side defined in the cutter drum face and the at least one inner circumferential row has first and second ends and first and second sides defined in the cutter drum face. First and second cutter plates are connected to first and second sides of the cutter drum, the first and second cutter plates defining a second side of the cutter bit slots in the first and second outer circumferential rows. A plurality of first cutter bits are connected in the cutter bit slots in the cutter drum face and a plurality of second cutter bits are connected to the first and second cutter plates.

In some embodiments the first cutter bits extend radially outwardly from the cutter drum face a first distance and the second cutter bits extend radially outwardly from the cutter drum face a second distance, the second distance being greater than the first distance.

The first and second cutter plates are non-destructively removable and replaceable. In some embodiments the first and second cutter plates comprise a plurality of separable cutter plate segments, each cutter plate segment being removably connected to the cutter drum.

The second cutter bits in some embodiments have a narrower width than a width of the first cutter bits.

The cutter plate segments may be laterally offset from adjacent cutter plate segments, and in some embodiments the first cutter bits in the first and second outer circumferential rows and at least a portion of the second cutter bits have no lateral space therebetween.

In an additional embodiment, a cutter comprises a cylindrical cutter drum having a first outer diameter, the cylindrical cutter drum defining a central opening configured to receive a shaft. First and second cutter plates are removably connected to the cutter drum, the first and second cutter plates having a second outer diameter, the second outer diameter being larger than the first outer diameter. A plurality of first cutter bits are connected to the cutter drum, at least a portion of the first cutter bits being positioned immediately adjacent the first cutter plate and at least portion of the first cutter bits positioned immediately adjacent the second cutter plate. A plurality of second cutter bits are connected to the first and second cutter plates.

The first cutter bits in some embodiments are arranged in circumferential rows including first and second outer circumferential rows and at least one inner circumferential row, the first cutter bits in the first and second outer circumferential rows positioned immediately adjacent the first and second cutter plates.

### DESCRIPTION

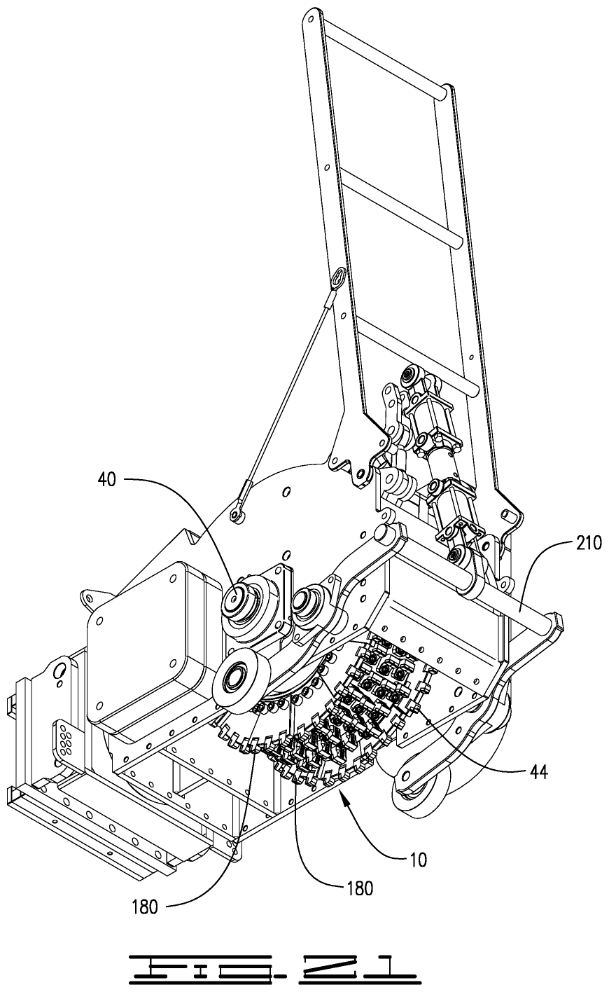

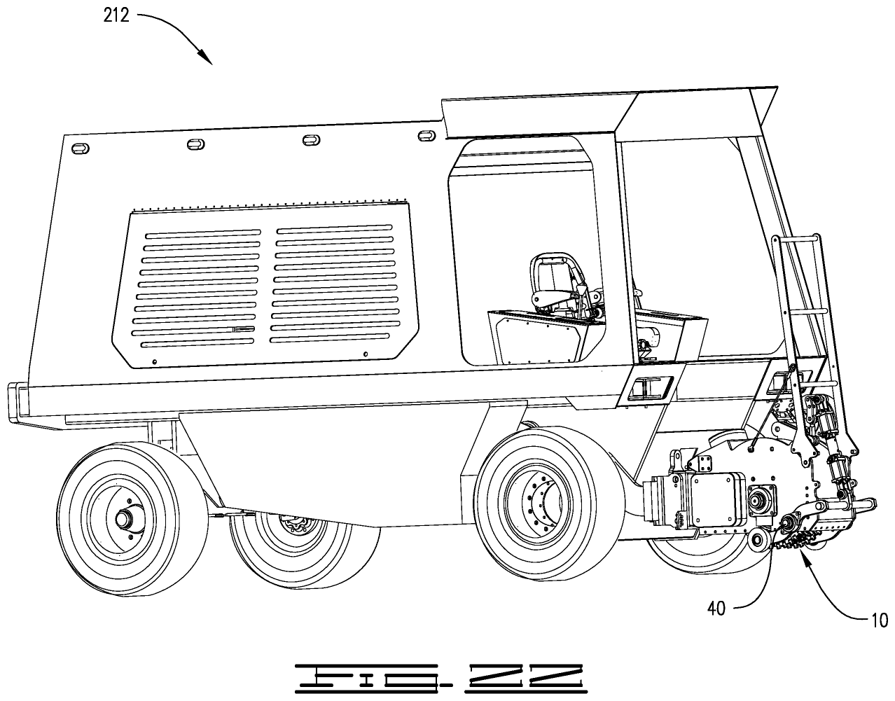

A cutter head assembly 10 configured to grind a portion of a surface 12 is shown. In the embodiment described the cutter head assembly 10 is configured to be connected to a wheeled vehicle 212 and utilized to cut grooves in the surface 12 of, for example, a roadway. The cutter head assembly 10 will be mounted utilizing a shaft 40 as shown in the figures, and will be rotated by a motor as it is moved along a roadway. Uses may include for example, cutting grooves in a roadway on the shoulder or the center thereof and cutting slots for the insertion of reflectors in a roadway. FIGS. 19-21 show an example of grooves 14 having a length 13 and a width 15. Grooves 14 have first and second outer groove portions 16 and 17 with a first depth 18. An inner groove portion 19 between first and second outer groove portions has a length 11, width 20 and a second depth 21. Second depth 21 is less than first depth 18.

Cutter head assembly 10 includes a cutter drum 23 with a width 24 that extends between first and second sides 25 and 26 thereof. The width 24 may be varied depending upon the width 15 of the cut desired. Cutter plates 27, which may comprise first and second cutter plates 28 and 30, are connected to cutter drum 23 at the first and second sides 25 and 26 thereof by welding or other known means. The overall width 31 of cutter head assembly 10 is equal to width 15 of groove 14. First cutter plate 28 is a right side cutter plate and second cutter plate 30 is a left side cutter plate.

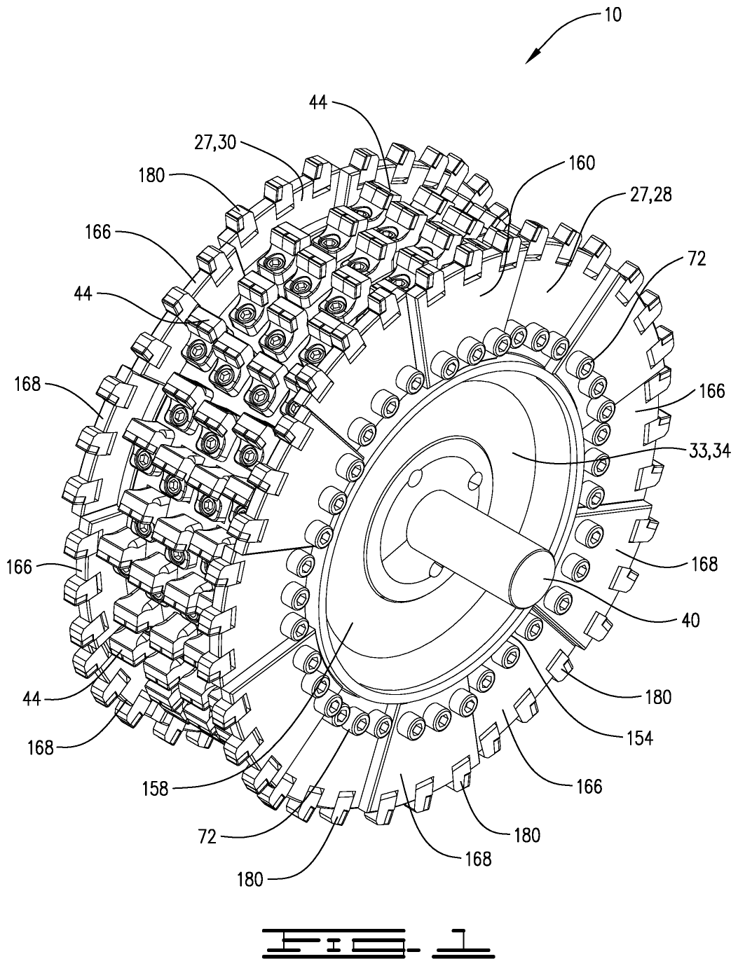

Cutter drum 23 comprises a cutter drum body 32 which is a generally cylindrical drum body 32 with side plates 33, which may comprise a first, right side plate 34 and a second or left side plate 36 connected thereto. Side plates 34 and 36 may be connected by welding or other means known in the art. In the embodiment described in FIG. 1, drum body 32 may be hollow which results in a cutter head assembly 10 generally much lighter than existing cutter head assemblies. First and second side plates 34 and 36 may have openings 38 therein with a key slot or other means for connecting a shaft 40 thereto. Drum body 32 has a drum face 42 thereon with a plurality of first cutter bits 44 mounted thereto. First cutter bits 44 are removably mounted to cutter drum 23 so that worn cutter bits can be easily removed and replaced with a new cutter bit. In other words, cutter bits 44 are non-destructively replaceable.

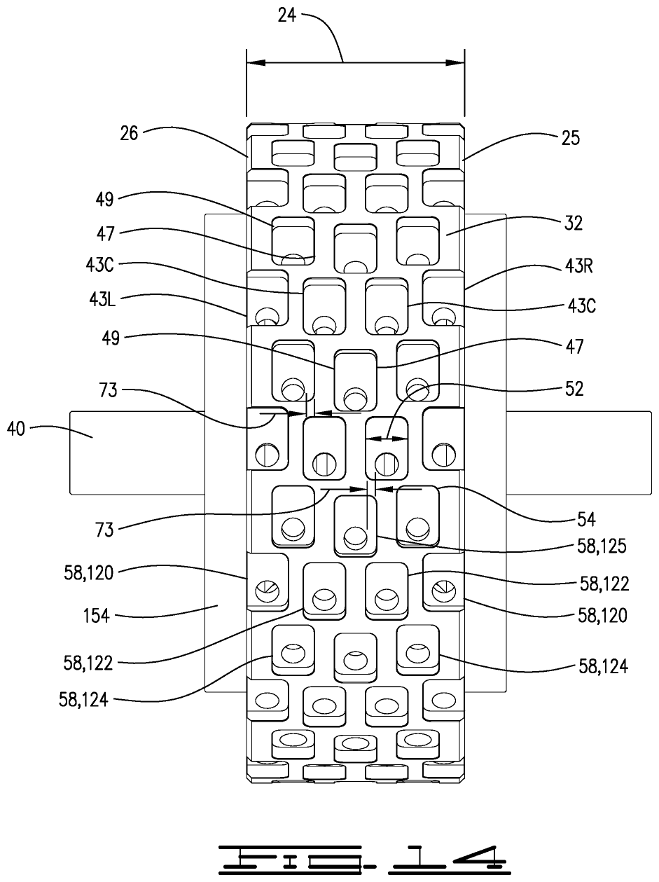

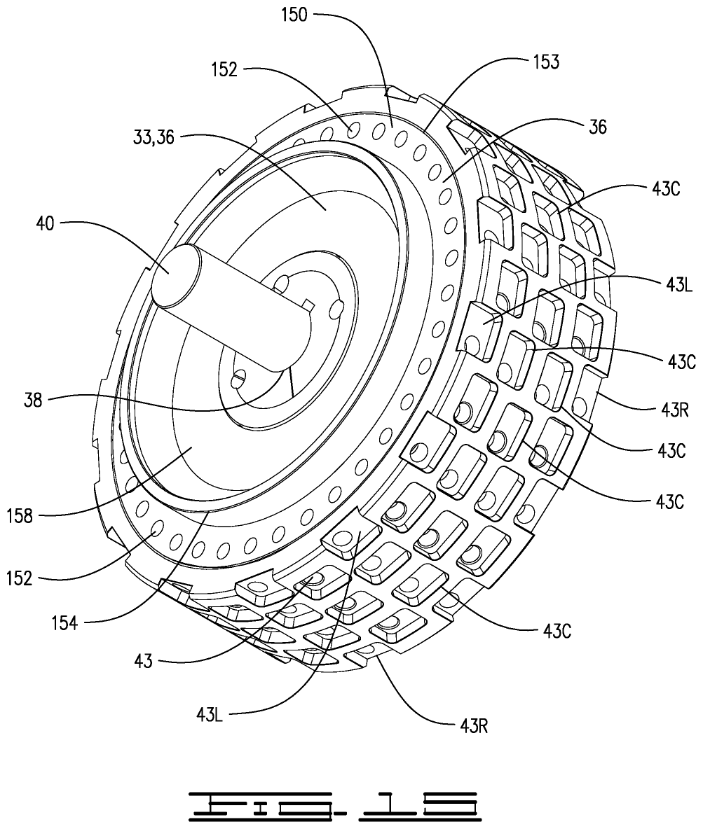

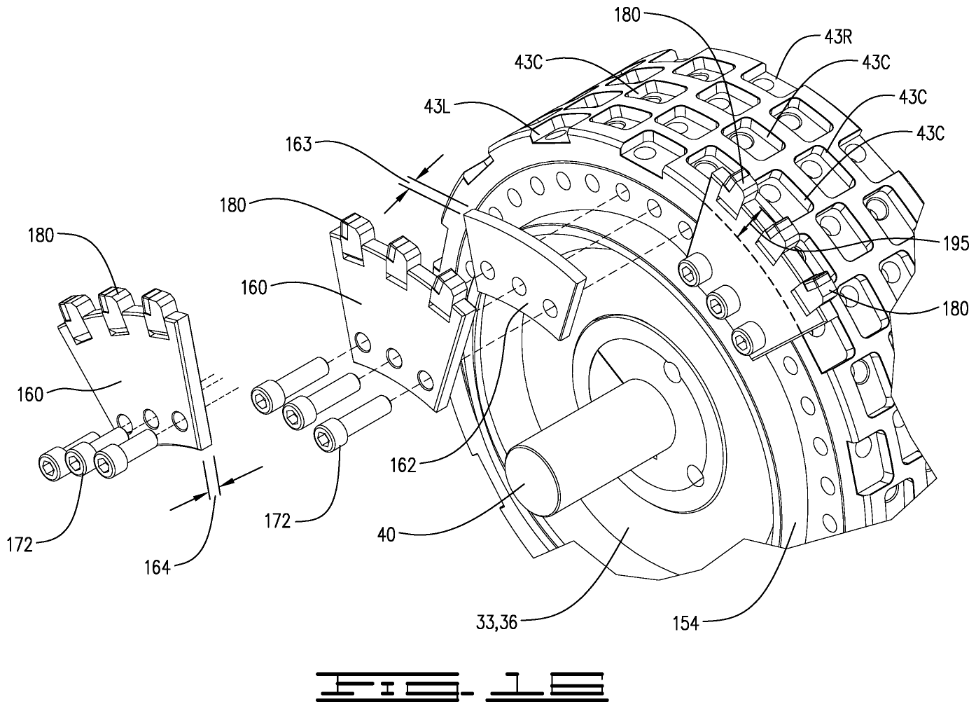

Drum face 42 may have a plurality of mounting slots 43 therein. An insert 48 is inserted by threading or otherwise into an opening in drum face 42 in mounting slot 43. FIG. 12 shows the attachment of cutter bits 44 to an embodiment of a cutter drum in mounting slots 43. The arrangement of the slots in FIG. 12 is not like that in the embodiment of FIG. 1, but the manner of connection is the same. In the embodiments shown threaded fasteners 50 extend through openings in cutter bits 44 and are threaded into inserts 48. By utilizing removable and replaceable cutter bits 44 worn or damaged cutter bits are easily and efficiently replaced. Inserts 48 are likewise removable and replaceable, so that if an insert is worn or damaged, there is no need to replace or repair the cutter drum 23. All that is required is the removal and replacement of the insert 48.

Mounting slots 43 are generally rectangular mounting slots with a width 52 and rounded corners 54. Rounded corners 54 prevent any stress concentrations and as a result lead to a longer cutter drum body life and a more robust, cutter head assembly 10 that is less subject to failures than existing assemblies. Mounting slots 43 include left side mounting slots 43L, center mounting slots 43C and right side mounting slots 43 R. Slots 43C are mounting slots that are spaced laterally inwardly from the right and left sides 25 and 26 of cutter drum 23. The embodiment of FIG. 1 has three circumferential rows of slots 43C, but depending on the width of the cut desired more or fewer circumferential rows of slots 43C can be included.

Each of mounting slots 43 have right and left side walls 47 and 49, rear edge 51 and forward edge 53, and a depth 56. The right and left side walls 47 and 49 of mounting slots 43C are defined on the face of the cutter drum. In other words, the side walls are formed by the mounting slots 43C in the cutter drum face 42. The right side of mounting slots 43R is formed by right cutter plate 28. Mounting slots 43R are formed so that there is no right side wall defined by cutter drum face 42, and the mounting slots 43R have a width that extends from the left side wall 49 thereof to the right outer edge of the cutter drum face 42. The left side wall of mounting slots 43L is formed by left cutter plate 30. Mounting slots 43L are formed so that there is no wall at the left side thereof in the cutter drum face 42, and the mounting slots 43L have a width that extends from the right side wall 47 thereof to the left outer edge of the cutter drum face 42. Cutter bits 44 extend radially outwardly a distance 45 from cutter drum face 42.

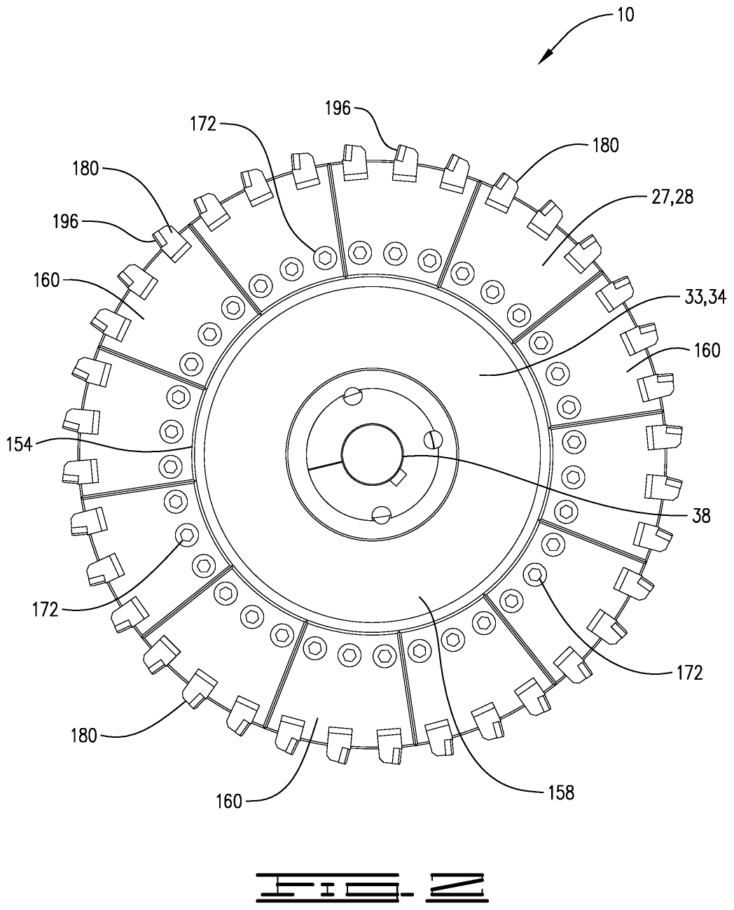

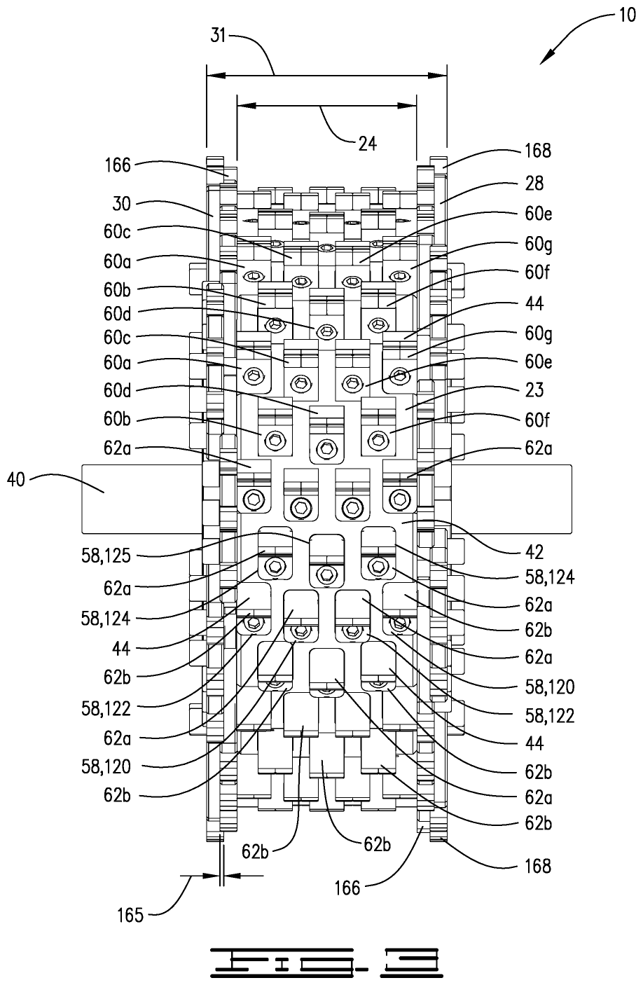

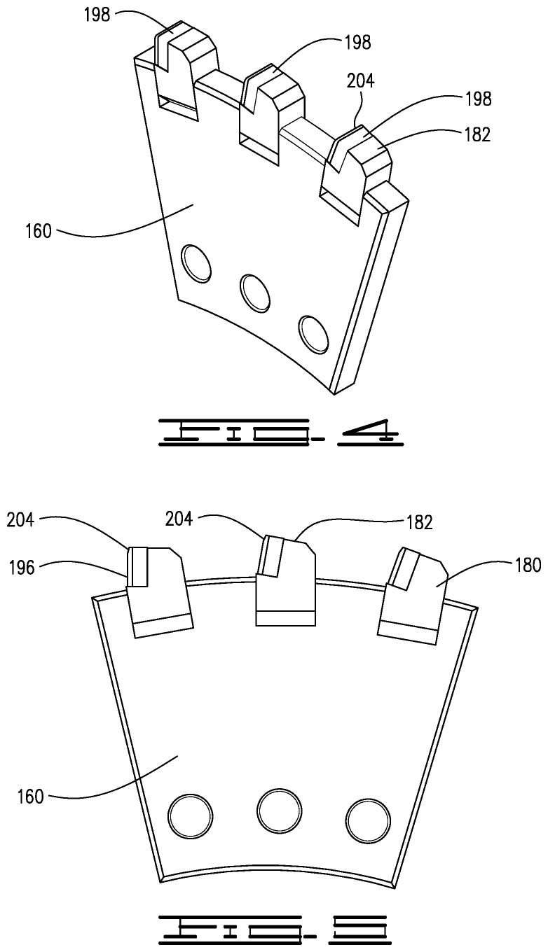

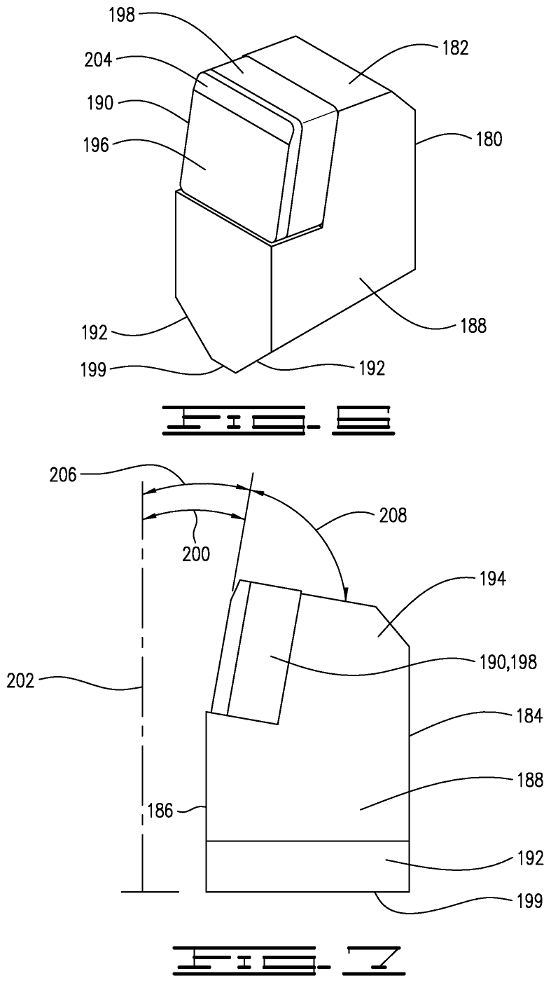

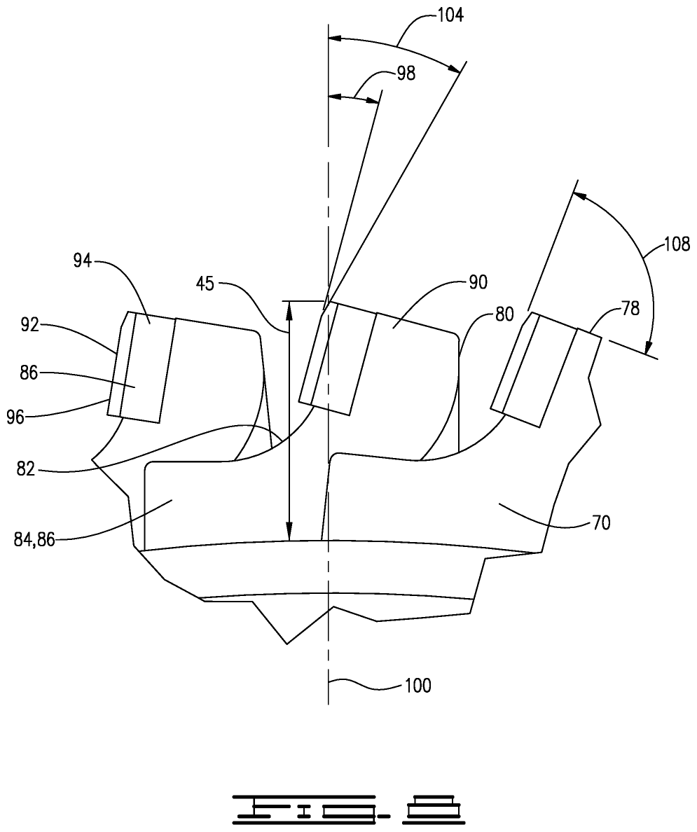

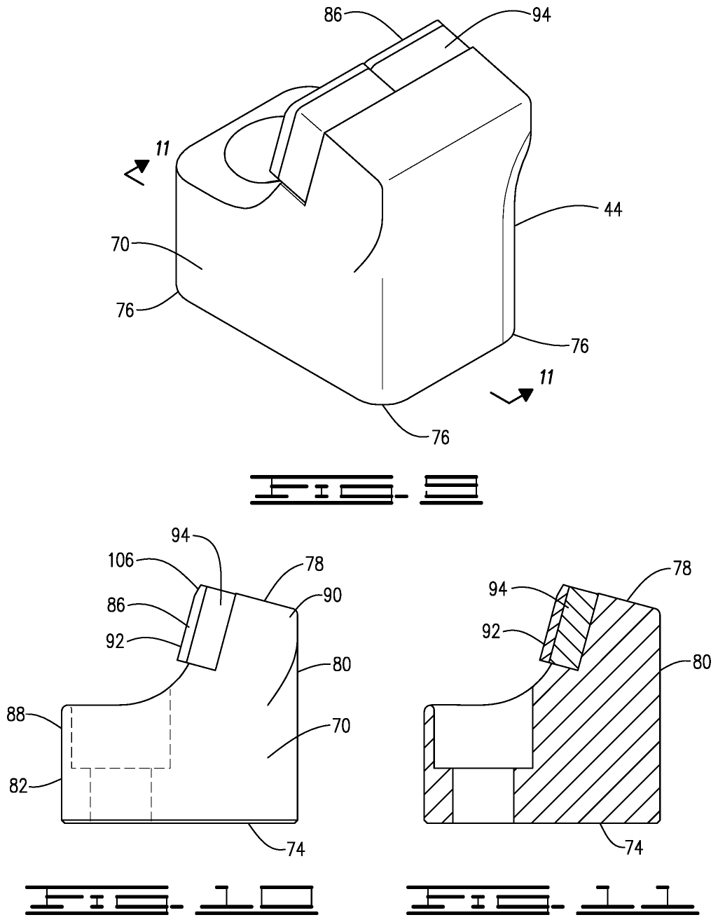

In the embodiment of FIGS. 1-3 mounting slots 43 and cutter bits 44 are arranged in a manner that may be described in different ways. Mounting slots 43 and the cutter bits 44 mounted therein are arranged in horizontal rows 58. Mounting slots 43 and cutter bits 44 mounted therein are also arranged in circumferential rows 60 and in V-shaped patterns 62 which are parallel V-shaped patterns 62. The cutter bits 44 in a V-shaped pattern are identified with a letter subscript. Only those patterns necessary to show the arrangement are marked for clarity's sake.

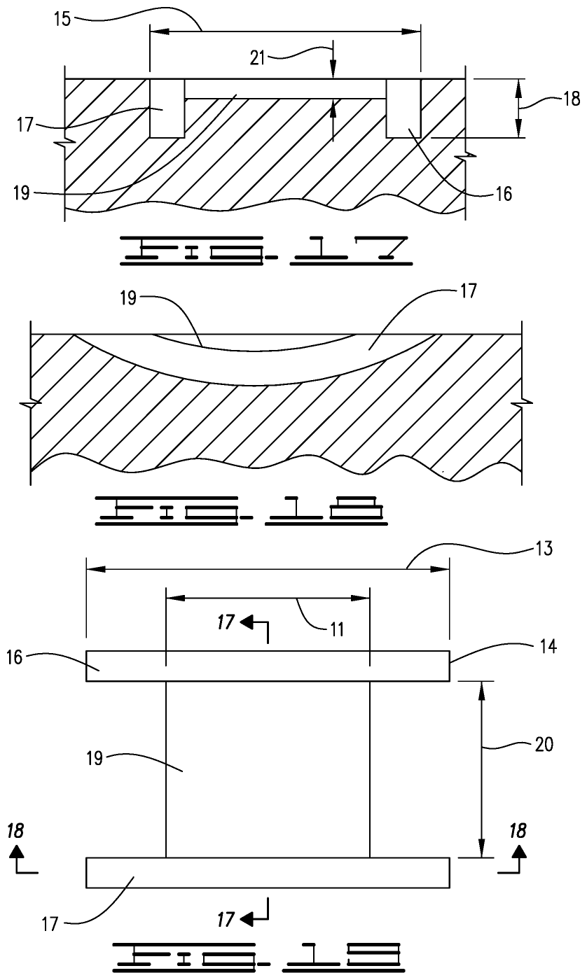

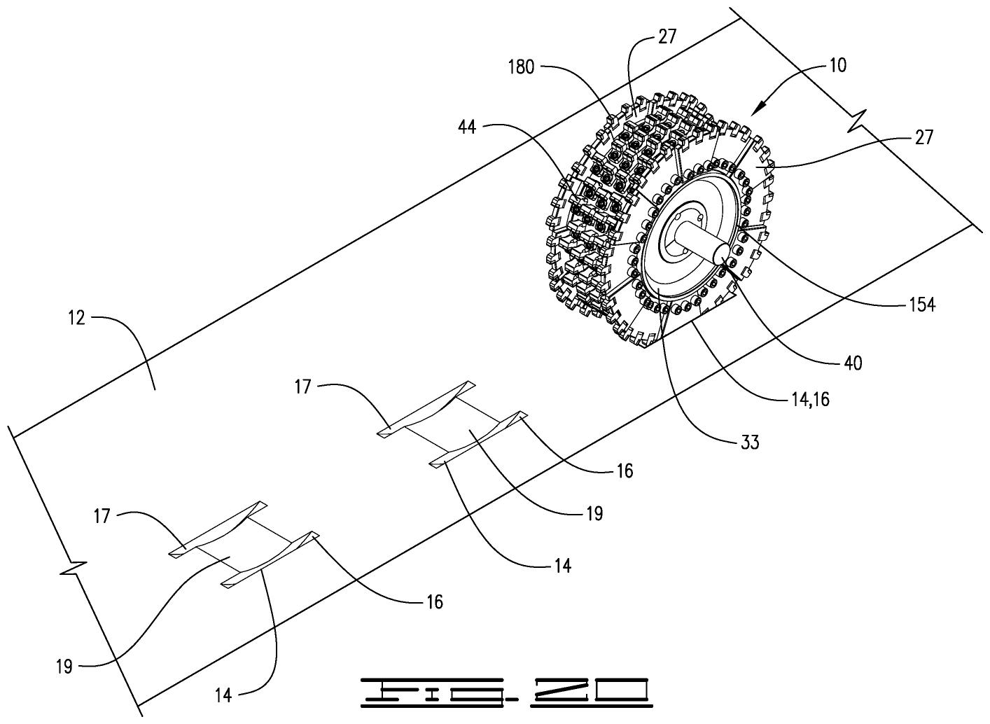

While in the embodiment shown in FIGS. 1-3 each of mounting slots 43 has a cutter bit 44 mounted therein it is understood that in some embodiments some mounting slots may include a filler plate 46. As depicted in FIG. 12 filler plates 46 are mounted in any slot 43 in which no cutter bit 44 is mounted. Filler plates 46 are mounted with threaded fasteners threaded into inserts 48. In certain circumstances it may be desirable to create narrow cuts of a single depth in a surface or spaced apart cuts with a single cutter head. For example, when no cutter pates 27 are attached, as shown in FIG. 16 cutter bits 44 may be connected in certain of mounting slots 43 and replaced with a filler plate 46. In this way the mounting slots 43 are protected and may be used to later mount a cutter bit 44 therein. For example, removing cutter bits 44 from the two outer circumferential rows 60 at each side of the cutter drum body 32 and replacing them with filler plates will result in a narrower cut than if first cutter bits 44 are placed in all of the mounting slots 43.

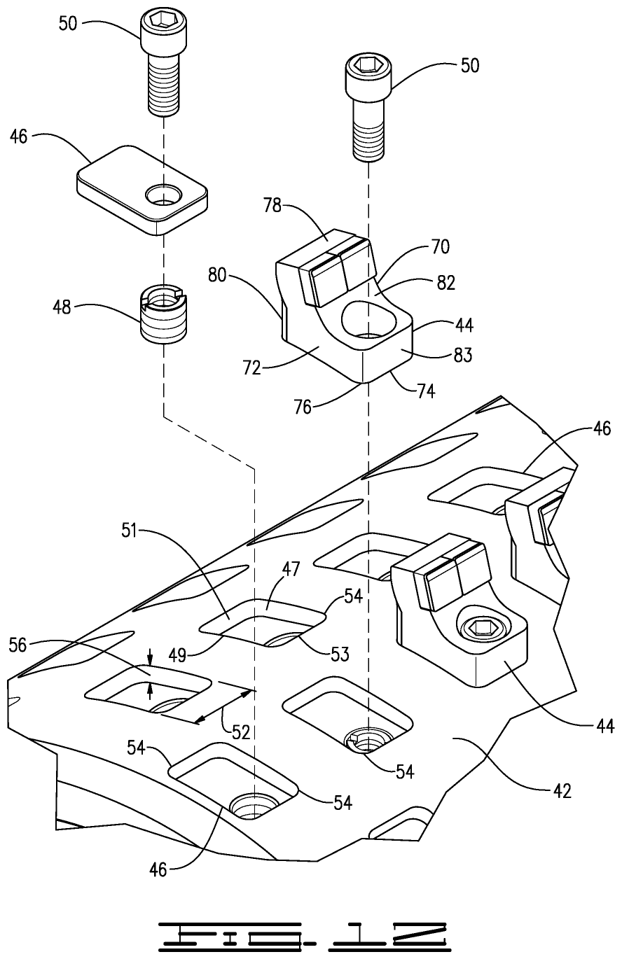

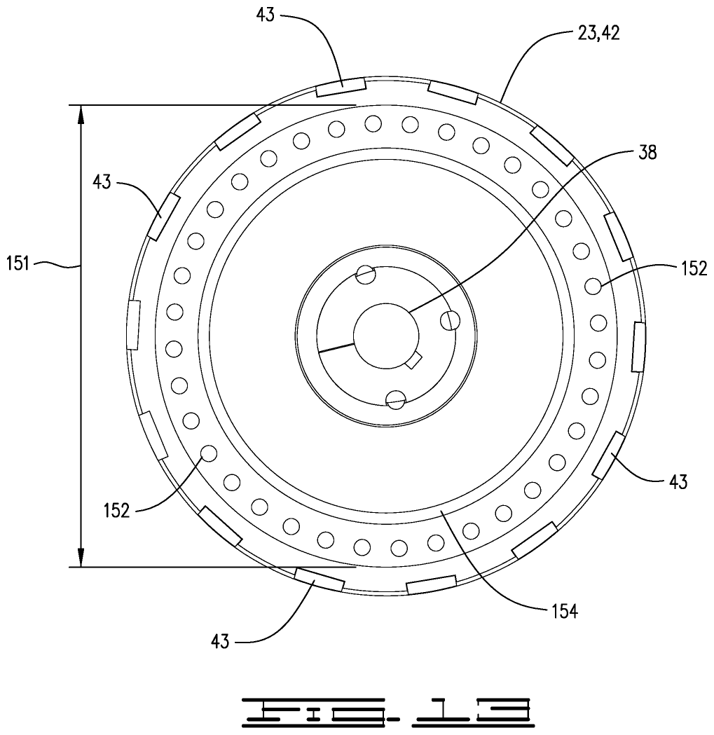

Referring to FIGS. 9-12 first cutter bits 44 have a right or first side 70 and a second or left side 72. Cutter bits 44 have a bottom surface 74 that in the embodiment shown is a flat rectangular shaped bottom surface 74 with rounded corners 76. Bottom surface 74 is configured to be closely received in mounting slots 43 and to protect the bottom surface thereof. During rotation of the cutter drum assembly the edges of cutter bits 44 are engaged by rear slot edge 51 which drives the first cutter bits 44 during the cutting of grooves in surface 12. In other words, fasteners 50 will carry very little load or force, if any, created when the cutter bits 44 engage and cut surface 12.

First cutter bit 44 has a top surface 78, a rear side 80 and a front or forward side 82. A forwardmost edge 83 is defined by forward side 82. Cutter bit 44 may be a multiple piece cutter bit that comprises a cutter bit body 84 and a cutter tooth 86 mounted thereto. Cutter bit body 84 may be made, for example, from forged steel, such as 4140 steel. Cutter bit 44 has base 88 with tooth portion 90 extending therefrom. Cutter tooth 86 is connected to and comprises a part of tooth portion 90.

A tooth face 92 is defined on cutter bit 44 and specifically on cutter tooth 86. Cutter tooth 86 is bonded to a connecting pad 94 which is made for example of carbide steel. Connecting pad 94 is mounted to body 84 by brazing or other known means. Cutter tooth 86 may be a polycrystalline diamond (PCD) cutter tooth. The hardness of PCD results in a cutter bit 44 with a longer operating life than other cutter bits. In the embodiment described rear side 80 is generally perpendicular to bottom surface 74, so that an angle 98 is defined by a line 100 perpendicular to bottom surface 74 and tooth face 92.

Tooth face 92 is thus angularly offset from a line 100 perpendicular to bottom surface 74 of the cutter bit 44. As a result, when cutter bit 44 is at the cutting position namely, at a position at which cutter bit 44 is engaging the surface being cut, tooth face 92 is angularly offset from a line through the center of the cutter drum. The line through the center of the cutter drum will be collinear with line 100 in the position described and is perpendicular to the bottom surface 74. Thus angle 98 is defined by and between tooth face 92 and line 100. Angle 98 is generally between 10 and 20 degrees and in one embodiment about 15 degrees.

Cutter tooth 86 has a leading edge 106 that is angularly offset from tooth face 92. Leading edge 106 is offset by an angle 104 from line 100 which may be in the range, for example, of 25 to 35 degrees and in one embodiment about 30 degrees. Top surface 78 and tooth face 92 define an angle 108. Angle 108 is such that top surface 78 will not drag against the ground surface during the cutting motion. In other words, as the cutter drum rotates and cuts into the surface 12, top surface 78 will not engage the ground surface 12. In the embodiment described angle 108 is for example between 85° and 95° and in one embodiment about 90°. As a result, top surface 78 is offset from line 100 at about an angle of about 100° to 110° which allows the cutter bit 44 to move through the cutting arc with no drag against surface 12 by top surface 78. Although the type of cut described herein is a plunge cut, in other words, a groove created by a plunging action of the cutter head assembly 10 as it rotates and is moved along surface 12, cutter drum assembly 10 may be used to remove paint lines from a roadway, cut slots for different types of markers and make other cuts to remove material from a surface.

In the embodiment of FIGS. 1-3 there are a plurality of horizontal rows 58. For example, horizontal rows 58 may include horizontal rows 120, 122 and 124 each of which includes two cutter bits 44 across the width of the cutter drum and a horizontal row 125 that includes a single cutter bit 44. The pattern will repeat so that there are a plurality of rows 120, 122, 124 and 125. The cutter bits 44 in a horizontal row are spaced laterally from one another.

In the arrangement shown FIGS. 1-3 there are a plurality of circumferential rows 60 and specifically seven rows 60 which are annotated with the letters a through g. The right side 47 of mounting slots 43 overlap left side 49 of mounting slots 43 in an adjacent circumferential row. As a result, the right side or first side 70 of a cutter bit 44 in a circumferential row 60 overlaps the left side 72 of the cutter bit 44 in the adjacent circumferential row 60. For example, the right side 70 of cutter bits 44 in circumferential row 60a will overlap the left side 72 of the cutter bits in circumferential row 60b. The right side 70 of cutter bit 44 in circumferential row 60b will overlap the left side 72 of cutter bits 44 in circumferential row 60c. Thus, as an example, assuming for example a slot and cutter bit 44 width of one inch and a lateral overlap 73 of one fourth of an inch, the width 24 of inner groove portion 19 is five and one-half inches. The amount of the overlap may vary depending upon the ultimate width of the cut desired. Assuming a width of one inch for each of cutter plates 28 and 30, the overall width 31 of grooves 14 is seven and one half inches. The cutter plate width can vary as described.

Side plates 33 each have an outer ring 150. Outer ring 150 has a plurality of openings 152 therein, which may be in one embodiment threaded openings for receiving a threaded connector. Side plates 33 are configured to fit inside a diameter 151 of cutter drum 23. Side plates 33 may be welded to an inner surface 153 of cutter drum 23. Side plates 33 have a flange 154 extending laterally outwardly from outer ring 150. Side plates 33 have center portion 158 with opening 38 therein.

Cutter plates 27 are segmented cutter plates that may comprise a plurality of cutter plate segments 160. Cutter plate segments 160 are separable and may be connected to a side plate 33 and removed and replaced independent of other cutter plate segments. In the embodiment described, each segment 160 is offset laterally from adjacent cutter plate segments 160. This is accomplished using spacers 162 to connect certain of the cutter plate segments 160 to side plates 33. In the embodiment described, a width 163 of spacer 162 is less than a width 164 of cutter plate segments 160. As a result, there is a lateral overlap 165 between the inner row 166 of cutter plates 27 and the outer row 168 of cutter plates 27. Assuming a cutter segment width 164 of three fourths of an inch, and a spacer width 163 of one half of an inch, the overall width of a cutter plate 27 is one inch. A plurality of bolts 172 or other connectors are inserted through openings in spacer 162 and threaded into openings 152. The widths of the cutter plates 160 and the spacers 162 can be varied to change the overall width 15 of groove 14, and if desired, the overlap 165 can be eliminated so that all segments 160 are laterally aligned. By varying the widths of the cutter plates 160 and spacers 162, the widths of outer groove portions 16 and 17 can also be varied. The use of cutter plate segments 160 and spacers 162 allows the width of cutter plates 27 to be varied easily which allows for the easy variation in the width of outer groove portions 16 and 17 and the overall width 15 of groove 14.

Cutter plates 27 include a plurality of second cutter bits 180 welded or otherwise connected to each segment 160. In the embodiment shown, at least a portion of the second cutter bits 180 are adjacent the first cutter bits 44 in the outer circumferential rows of the first cutter bits 44 and have no lateral space therebetween. Second cutter bits 180 are welded or otherwise connected to cutter plates 27. Second cutter bits 180 have top surface 182, a rear side 184 and a front or forward side 186. Second cutter bit 180 may be a multiple piece second cutter bit 180 that comprises a cutter bit body 188 and a cutter tooth 190 mounted thereto. Cutter bit body 188 may be made, for example, from forged steel, such as 4140 steel. Second cutter bit body 188 has base 192 with tooth portion 194 extending therefrom. Cutter tooth 190 is connected to and comprises a part of tooth portion 194. Cutter bits 180 extend radially outwardly a distance 195 from cutter drum face 42 a distance 195. Distance 195 is greater than distance 45 so that outer groove portions 16 and 17 will be deeper than inner groove portion 19. Second cutter bits 180 thus extend radially outwardly from the cutter drum face and from a center of the cutter drum than do first cutter bits 44.

A tooth face 196 is defined on second cutter bit 180 and specifically on cutter tooth 190. Cutter tooth 190 is bonded to a connecting pad 198 which is made for example of carbide steel. Connecting pad 198 is mounted to body 188 by brazing or other known means. Cutter tooth 190 may be a polycrystalline diamond (PCD) cutter tooth. The hardness of PCD results in a cutter bit 180 with a longer operating life than other cutter bits. In the embodiment described rear side 184 is generally perpendicular to a bottom surface 199, and an angle 200 is defined by tooth face 196 and a line 202 perpendicular to bottom surface 199.

Tooth face 196 is thus angularly offset from line 202 such that when second cutter bit 180 is at the cutting position, namely, at a position at which cutter bit 180 is engaging the surface being cut, tooth face 196 is angularly offset from a line 201 though the center of the cutter drum. The line 201 through the center of the cutter drum is parallel with line 202 in the position described. Angle 200 is generally between 7 and 13 degrees and in one embodiment about 10 degrees.

Second cutter bit 180 has a leading edge 204 that is angularly offset from tooth face 196. Leading edge 204 is offset by an angle 206 from line 202 which may be in the range, for example, of 20 to 30 degrees and in one embodiment about 25 degrees. Top surface 182 and tooth face 196 define an angle 208. Angle 208 is such that top surface 182 will not drag against the ground surface during the cutting motion. In other words, as the cutter head assembly 10 rotates and cuts into the surface 12 top surface 182 will not engage the ground surface 12. In the embodiment described angle 208 is for example between 85° and 95° and in one embodiment about 90°. As a result, top surface 182 is offset from line 202 at an angle of about 100° to 110° which allows the second cutter bits 180 to move through the cutting arc with no drag against surface 12 by top surface 182. Although the type of cut described herein is a plunge cut, in other words, a groove created by a plunging action of the cutter head assembly 10 as it rotates and is moved along surface 12, cutter head assembly 10 may make other types of cuts.

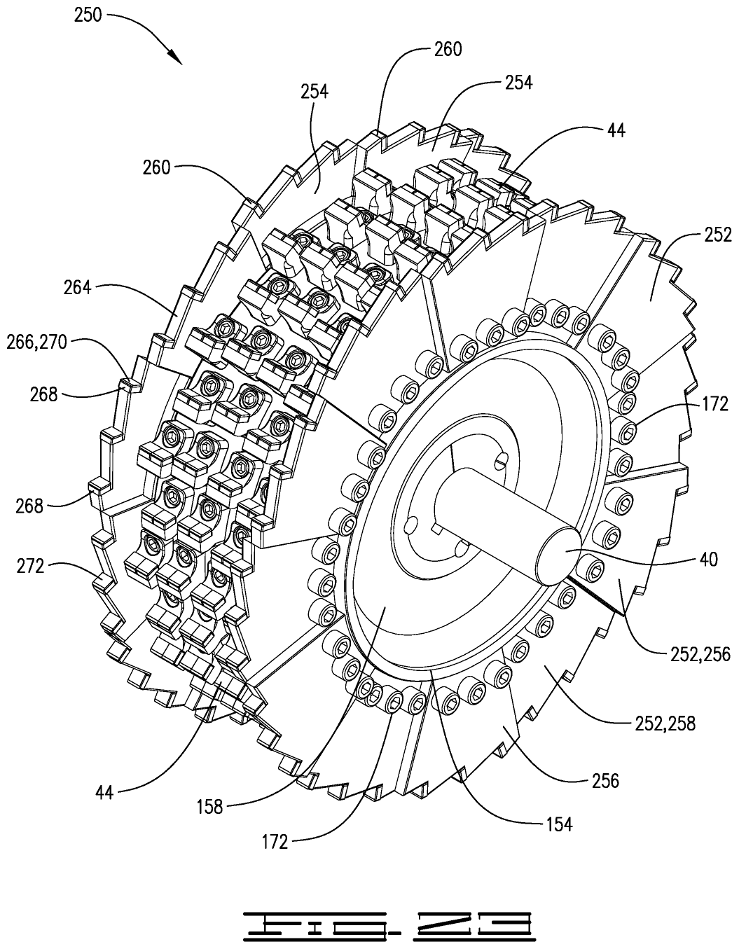

In operation the cutter head assembly 10 may be repetitively moved into and out of engagement to make grooves 14 as previously described. In so doing, grooves for the receipt of reflectors with side legs extending downward from a reflector body as shown in FIG. 26 may be placed and retained in the groove. Reflectors 214 include a reflector body 216 with legs 218 extending downwardly therefrom. Legs 218 will be received in outer groove portions 16 and 17 and body 216 received in inner groove portion 19. Cutter head assembly 10 is shown attached to a tool 210 in FIG. 21 and attached to a wheeled vehicle 212 in FIG. 22.

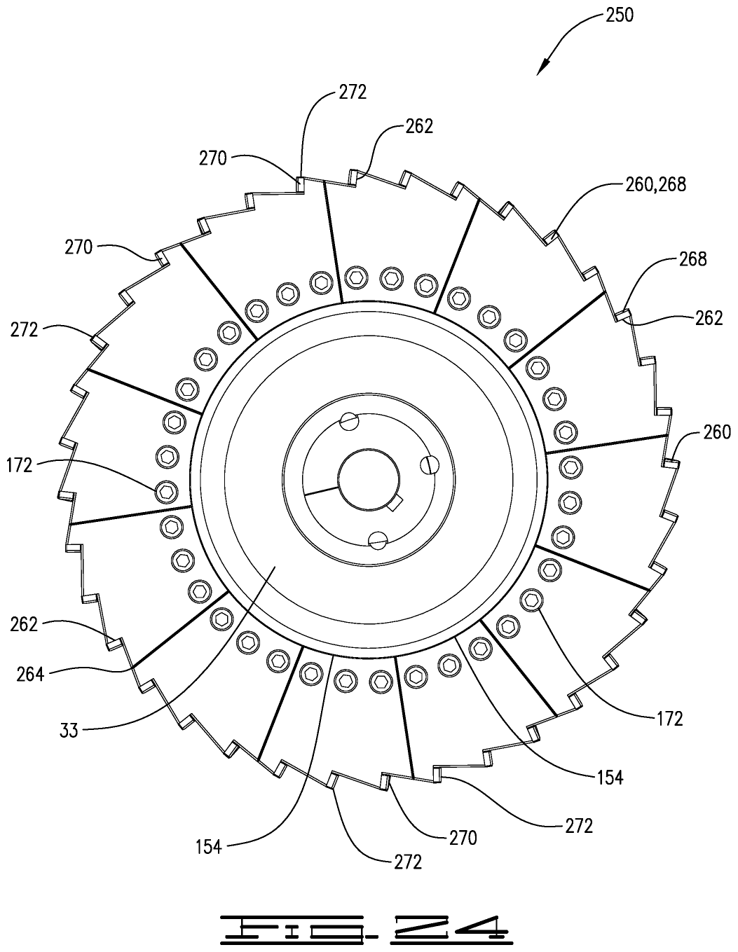

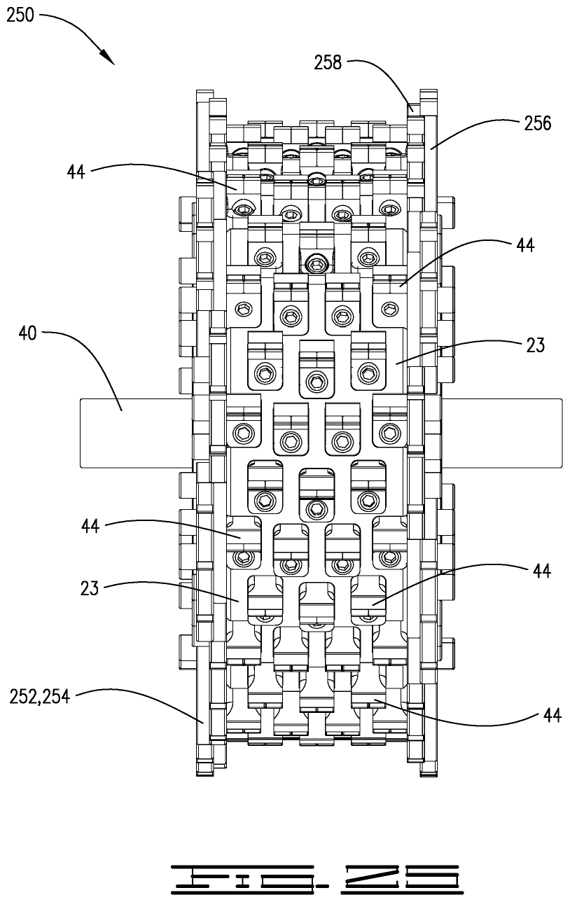

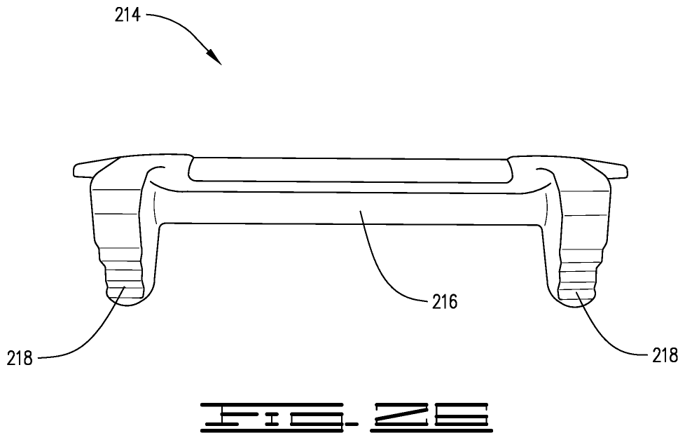

In an alternative arrangement shown in FIGS. 23-25, a cutter head assembly 250 is shown. Cutter head assembly 250 is generally identical to cutter head assembly 10, except for the configuration of the cutter plates. In the embodiments of FIGS. 23-25 cutter plates 252 are used as opposed to cutter plates 27. Cutter plates 252 are segmented cutter plates with a plurality of cutter plate segments 254. The cutter plate segments can be arranged in an outer row 256 and an inner row 258 so that the cutter plate segments 254 are laterally offset from an adjacent cutter plate 252 by using spacers 162 as described above, or can be aligned without the use of spacers 162. Cutter plates 252 have cutter bits 260 connected to cutter plate segments 254. Cutter plate segments 254 have a plurality of circumferentially spaced connecting faces 262 defined on an outer periphery 264 of the cutter plate segments 254. In the embodiment described each segment 254 includes three cutter faces 262. Cutter bits 260 are comprised of a cutter tooth 266 attached to a connecting pad 268, which is connected by brazing or other means directly to a cutter tooth segment. The cutter tooth 266 and connecting pads 268 are generally identical to cutter tooth 190 and connecting pad 198. Cutter head assembly 250 operates in the same way as cutter head assembly 10. Cutter tooth 266 thus has tooth face 270 and leading edge 272, angled as described with respect to cutter tooth 190. Both of cutter head assemblies 10 and 250 will be rotated at a sufficient speed to cut grooves in the roadway, as they are moved along by a tool or vehicle to which they are attached.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention.

What is claimed is:

1. A cutter head assembly for cutting slots in a surface comprising:
a cutter drum;
a plurality of first cutter bits connected to the cutter drum, the first cutter bits extending radially outwardly a first distance from a cutter drum face;
first and second cutter plates connected to first and second sides of the cutter drum;
a plurality of second cutter bits connected to the first and second cutter plates, the second cutter bits extending radially outwardly a second distance from the cutter drum face, the second distance being greater than the first distance.

2. The cutter head assembly of claim 1, the first and second cutter plates comprising a plurality of cutter plate segments, each cutter plate segment having a plurality of second cutter bits connected thereto.

3. The cutter head assembly of claim 2, the first and second cutter plates comprising a plurality of substantially similarly shaped segments.

4. The cutter head assembly of claim 2, each segment being laterally offset from an adjacent cutter plate segment.

5. The cutter head assembly of claim 1, the first and second cutter plates being bolted to the cutter drum.

6. The cutter head assembly of claim 1, the second cutter bits being welded to the first and second cutter plates.

7. The cutter head assembly of claim 1, the first cutter bits comprising first and second outer circumferential rows of first cutter bits, and at least one inner circumferential row of first cutter bits, the first and second outer rows being positioned immediately adjacent the first and second cutter plates.

8. A cutter for cutting a groove in a ground surface comprising:
a cylindrical cutter drum;
a plurality of cutter bit slots defined in a cutter drum face, the cutter bit slots being arranged in circumferential rows comprising first and second outer circumferential rows and at least one inner circumferential row, the cutter bit slots in the first and second outer circumferential rows having first and second ends and a first side defined in the cutter drum face and the at least one inner circumferential row having first and second ends and first and second sides defined in the cutter drum face;
first and second cutter plates connected to first and second sides of the cutter drum, the first and second cutter plates defining a second side of the cutter bit slots in the first and second outer circumferential rows;
a plurality of first cutter bits connected in the cutter bit slots in the cutter drum face; and
a plurality of second cutter bits connected to the first and second cutter plates.

9. The cutter of claim 8, the first cutter bits extending radially outwardly from the cutter drum face a first distance and the second cutter bits extending radially outwardly from the cutter drum face a second distance, the second distance being greater than the first distance.

10. The cutter of claim 8, the first and second cutter plates being non-destructively removable and replaceable.

11. The cutter of claim 8, the first and second cutter plates comprising a plurality of separable cutter plate segments, each cutter plate segment being removably connected to the cutter drum.

12. The cutter of claim 8, the second cutter bits having a narrower width than a width of the first cutter bits.

13. The cutter of claim 8, the cutter plate segments each being laterally offset from adjacent cutter plate segments.

14. The cutter of claim 8, the first cutter bits in the first and second outer circumferential rows and at least a portion of the second cutter bits having no lateral space therebetween.

15. A cutter comprising:
a cylindrical cutter drum having a first outer diameter, the cylindrical cutter drum defining a central opening configured to receive a shaft;
first and second cutter plates removably connected to the cutter drum, the first and second cutter plates having a second outer diameter, the second outer diameter being larger than the first outer diameter;
a plurality of first cutter bits connected to the cutter drum, at least a portion of the first cutter bits being positioned immediately adjacent the first cutter plate and at least portion of the first cutter bits positioned immediately adjacent the second cutter plate; and
a plurality of second cutter bits connected to the first and second cutter plates.

16. The cutter of claim 15, the first cutter bits being arranged in circumferential rows including first and second outer circumferential rows and at least one inner circumferential row, the first cutter bits in the first and second outer circumferential rows positioned immediately adjacent the first and second cutter plates.

17. The cutter of claim 15, the first and second cutter plates comprising a plurality of cutter plate segments.

18. The cutter of claim 17, the cutter plate segments being offset from adjacent cutter plate segments.

19. The cutter of claim 15, the second cutter bits being welded to the first and second cutter plates.

20. The cutter of claim 15, the second cutter bits extending radially outwardly a distance greater than the first cutter bits.
